(19) United States
(12) Patent Application Publication
(10) Pub. No.: US 2026/0178338 A1
(43) Pub. Date: Jun. 25, 2026

(54) System and Methods for Neural Instruction Scheduling

(71) Applicant: Advanced Micro Devices, Inc., Santa Clara, CA (US)

(72) Inventors: Ian Charles Colbert, San Diego, CA (US); Jake Matthew Daly, Belmont, CA (US)

(21) Appl. No.: 18/999,063

(22) Filed: Dec. 23, 2024

(51) Int. Cl. G06F 9/38

(52) U.S. Cl. CPC G06F 9/3838

(57) ABSTRACT

Systems and methods are described for scheduling instructions corresponding to a computer program. A neural instruction scheduler operates by iterating over all the basic blocks (BBs) in the directed acyclic graph (DAG). The nodes of the DAG, which represent instructions in the form of compiler IR, are tokenized such that tokens retrieve embeddings from an embedding space. These embeddings are aggregated into a single vector that represents the instructions in a latent semantic space. The embeddings are fed into a value estimator which predicts performance metrics associated with scheduling each valid instruction and compares them against one another to determine which instruction to pick next. The process of picking the next instruction can begin using the same approach. This process is autoregressively repeated for all valid instructions. Candidate instruction schedule(s) with identified ordering of instructions are output and an instruction schedule is selected to schedule each basic block.

### BACKGROUND

### Description of the Related Art

Compilers use instruction schedulers to optimize the order in which instructions are executed on hardware without compromising the function of a program. Traditional instruction schedulers rely on a suite of algorithms designed to generate candidate schedules for a given basic block using heuristics that are meticulously hand-tuned by an expert compiler engineer. This process is an expensive task as the heuristics require constant re-tuning as new games with new shaders are introduced. These re-tunings are necessitated as the compiler and driver stack are constantly changing as they are being developed. Further, when new SoCs are launched, more complex changes in the distribution of data and schedules are caused, thereby requiring complicated changes to the heuristics.

Modern graphics architectures contain many highly specialized compute cores and memory hierarchies that tend to create intricate instruction and data-level dependencies. GPU compilers rely heavily on instruction schedulers to organize workloads in a way that most efficiently utilizes these hardware resources. However, achieving high efficiency often requires balancing objectives that conflict with one another; for example, keeping register pressure low allows more threads to be launched, but launching too many threads can hurt instruction latency. Instruction schedulers simplify this complex optimization problem by: (1) focusing on a single optimization objective at a time (e.g., minimizing latency or maximizing occupancy); and (2) using multiple heuristics to estimate runtime behavior from static analysis of source code. Even then, selecting the optimal schedule is highly non-trivial due to the large space of valid, functionally equivalent schedules.

Known solutions include a trial-and-error approach where the scheduler greedily tries different strategies, scores each one, and then selects the one with the best score. Other solutions include instruction schedulers that uses a deep neural network to select the best scheduling strategy based on the incoming intermediate representation (IR) of the shader. Even with such schedulers, the instruction scheduling process is dependent on a fixed set of heuristics that are manually designed. These approaches are inherently subject to human biases, which can limit the effectiveness and efficiency of the scheduling process. Additionally, the manual design of these heuristics restricts both the number of unique schedules that can be produced (thus potentially missing out on better instruction orderings) and also impacts the frequency in which these heuristics can be updated.

In view of the above, improved systems and methods for instructions scheduling in computer architectures are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates a block diagram of one implementation of a compiler system.

FIG. 3 illustrates a block diagram describing generation of instruction schedules based on a shader control flow graph (CFG).

FIG. 4 illustrates a block diagram of various components of a neural instruction scheduler.

FIG. 5 illustrates a block diagram for training a neural instruction scheduler using reinforcement learning.

FIG. 6 illustrates a method for generating candidate schedules for scheduling instructions corresponding to a computer program.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems and methods are disclosed for scheduling instructions that optimize the order in which instructions are executed on specific hardware without compromising the function of a program. Traditional heuristic-based scheduling mechanisms include independently scheduling each basic block a given number of times, such that each time a candidate schedule is generated according to unique heuristic. Each resulting schedule is assigned a score by an evaluation heuristic that analyzes and scores the orderings. The instruction ordering that yields the best score is kept as the final schedule for that basic block. In such approaches, the scheduler chooses the next instruction based off of a set of rules encapsulating knowledge of which types of instruction sequences are known to work better (relative to the other candidates) when issued next to each other. Effectively, different sets of rules are implemented as different scheduling heuristics that get applied to each basic block in a trial-and-error approach to determine which scheduling strategy generated the best schedule according to a tuned evaluation function.

Some alternate solutions may use a discriminative neural network (e.g., a transformer-based language model) to proactively predict the optimal scheduling strategy directly from the incoming intermediate representation (IR), eliminating the exhaustive trial-and-error process to save compile time. This can include a machine learning (ML)-guided scheduler that leverages discriminative neural networks to proactively choose a scheduling algorithm, rather than the brute force trial-and-error approach. While this has proven to be successful in speeding up compile time by limiting the costly evaluation of suboptimal scheduling algorithms, this approach still relies on the existence of several unique scheduling algorithms to produce schedules.

The systems and methods described herein address these issues by configuring an end-to-end neural instruction scheduler for scheduling instructions. A system-level design infuses mechanics of ready-list instruction scheduling into an autoregressive neural network. This approach allows for generation of an arbitrarily large number of schedules, significantly expanding the potential solution space. The ready lists are used to ensure that a valid instruction schedule is generated. In one implementation, using these ready lists narrows the number of valid instruction schedules from N! (where N is the number of instructions in a basic block) to a compact set of legal schedules, e.g., a number that can be computed from the basic block's directed acrylic graph (DAG). Using the machine learning inference approach, as proposed herein, enables generation of a valid instruction schedule using no more than N−1 inferences. In one implementation, to tackle the complex state space, neural approximations of performance metrics (e.g., predicted GPU runtimes, memory usage, etc.) are used to drive the described neural instruction scheduler, as this can be more scalable than using real-world performance parameters. More importantly, the neural instruction scheduler described herein orders the instructions based on learned patterns and data-driven value estimation, rather than adhering to any pre-determined heuristic or strategy. This novel approach to instruction scheduling can enable more flexible instruction scheduling, overcoming the limitations and biases inherent in the current heuristic-based approach.

The solutions described herein provide several advantages, including but not limited to, runtime improvements attained through producing better schedules. Further, code representation is automatic and with limited, if any, human bias. The presented solutions further eliminate the need to spend expensive engineering and machine hours developing and tuning heuristics. As the value estimation model improves, one can fully automate retraining the model to further improve performance.

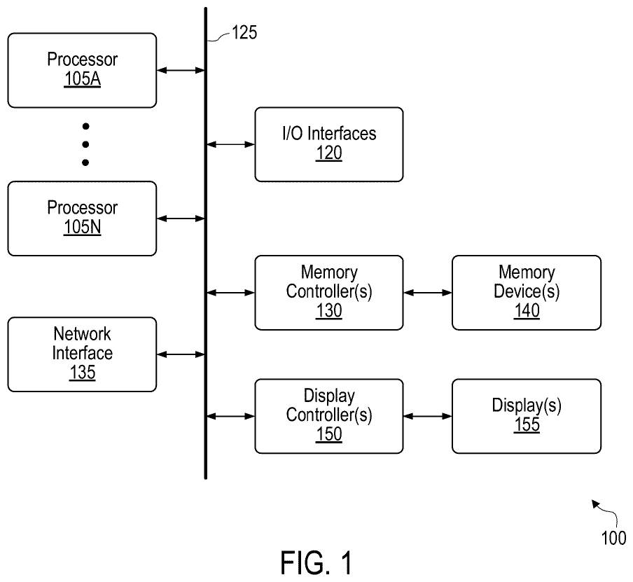

Referring now to FIG. 1, a block diagram of one implementation of a computing system 100 is shown. In an implementation, computing system 100 is configured to, amongst other functionalities, process data, such as but not limited to, automated translation and optimization of source code into machine-executable code. The system 100 receives source code written in a high-level programming language and performs lexical analysis, syntax analysis, semantic analysis, optimization, and target code generation based on the source code. The system 100 is further configured to output compiled, machine-executable code to a designated storage medium or execution environment. Additionally, the system 100 can include a feedback loop to provide warnings, errors, and suggestions allowing for iterative improvements and code debugging. The system 100 is capable of handling various programming languages and output formats and can be adaptable to include updates that optimize specific machine architectures or processing requirements.

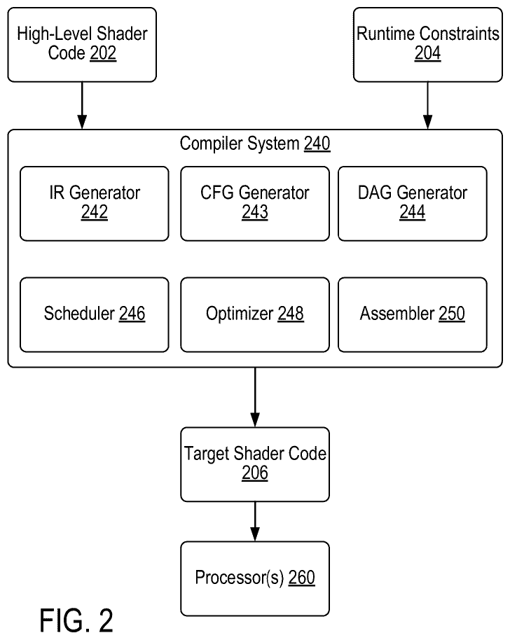

In one or more implementations, the system 100 executes specialized neural networks or machine learning models, e.g., for generating instruction schedules tailored for computer programs, e.g., compilers that use instruction scheduling. These programs are configured to analyze an intermediate representation of computer program code to determine an optimal sequence of instructions that maximizes parallel execution and minimizes latency. Further, these neural networks or machine learning models can be trained to improve criteria when executing the computer code, such as maximizing throughput and improving overall system efficiency. By considering factors such as data dependencies, execution circuitries, and register availability, the system 100 arranges instructions to enhance performance on the target graphics processing unit (GPU). The instruction scheduling process described herein ensures efficient utilization of the GPU pipeline, reducing stalls and improving rendering throughput for complex shader operations. This results in a compiled shader program that operates with higher efficiency and reduced computational overhead. These and other implementations are explained in detail with respect to subsequent FIGS. 2 to 7.

In one implementation, computing system 100 includes at least processors 105A-N, input/output (I/O) interfaces 120, bus 125, memory controller(s) 130, network interface 135, memory device(s) 140, display controller(s) 150, and display(s) 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 2-7 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, television, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

FIG. 2 illustrates a block diagram of one implementation of a compiler system. The compiler system is configured to compile computer program code. Computer program code as described herein is a structured sequence of instructions, commands, or syntactic representations designed to be executed by a computer processor (e.g., processor(s) 260), whereby said instructions facilitate the implementation of specified computational processes, algorithms, or functionalities. This code encompasses a range of coding languages or script formats, including but not limited to low-level machine code, assembly language, and high-level programming constructs. A specific implementation of such computer includes high-level shader code 202, which pertains to a set of specialized instructions developed for rendering graphics, executed on a graphics processing unit (GPU). Shader code 202 can include vertex shaders, pixel shaders, geometry shaders, or compute shaders, each providing procedural logic for manipulating graphical data, rendering visuals, and defining lighting, shading, texturing, or other visual effects within the context of computer-generated imagery or real-time rendering applications. Such high-level shader code 202 is characterized by its structured syntax in a high-level programming language, such as HLSL (High-Level Shading Language), GLSL (OpenGL Shading Language), or similar platforms, which is compiled or interpreted to perform parallelized computations on graphical data arrays or vertices and pixels within a graphics pipeline.

In one or more implementations described with respect to FIG. 2, a computing system (such as system 100) comprises the high-level shader code 202 and runtime constraints 204, which are provided as inputs to a compiler system 240. The compiler system 240, in one example, generates a target shader code 206 that is fed into the processor(s) 260 for execution. Each of these components, along with any sub-components, is described in more detail below. While a specific configuration of components is detailed here, in alternative implementations, the system can include different components, and these components may carry out the functions described herein in a different sequence or through different methods.

The runtime constraints 204 establish various execution limits for the high-level shader code 202 when it is run on the processor 260 after being compiled by the compiler system 240. These runtime constraints 204, also known as target constraints, may be provided by a vendor, user, or another entity intending to utilize the high-level shader code 202. The runtime constraints 204 can include factors such as execution time, power consumption, thermal output from running the code, hardware usage, hardware version limitations, and other execution characteristics. These constraints can be defined using any measurement type, whether as relative measures or direct values. For instance, execution time constraints could be specified in terms of time or clock cycles. Power usage constraints could be defined by total energy in joules, power consumption per unit time, or average power over time. Once these runtime constraints 204 are provided, the compiler system 240 attempts to produce a target code 206 that adheres to or satisfies these constraints 204.

The compiler system 240 further includes an intermediate representation generator (IR generator) 242, a control flow graph (CFG) generator 243, a directed acyclic graph (DAG) generator 244, a scheduler 246, a constraint optimizer 248, and an assembler 250, amongst other components. These components, in various implementations, are executed using dedicated or specialized hardware components designed to assist in the translation, optimization, and generation of machine-level code from high-level source code. These circuitries can include, but are not limited to, logic units, registers, processing cores, and memory buffers that facilitate parallel processing, data flow analysis, and rapid code transformation. Further, hardware accelerators, such as field-programmable gate arrays (FPGAs) or application-specific integrated circuits (ASICs), can also be incorporated within a compiler architecture to expedite specific compilation processes, such as syntax parsing, semantic analysis, and intermediate code generation. Other implementations are possible and are contemplated. In an implementation, IR and CFG generated by the IR generator 242 and CFG generator 243 are stored in a memory (not shown) corresponding to the compiler system 240, such that it can be accessed by other processing circuitries of the compiler system 240.

The IR generator 242 is configured for processing the high-level shader code 202 to generate an intermediate representation (IR) by translating the high-level shader source code 202 into an abstract, platform-independent format. This IR serves as an intermediary stage within the compilation pipeline, facilitating optimization and transformation processes that enhance execution efficiency and compatibility across different hardware architectures. The IR maintains essential information regarding shader program logic, including data flow, control structures, and mathematical operations, in a structured format that can be further refined. The generation of IR enables the compiler system 240 to perform code analysis and optimization steps before producing a final, platform-specific target code 206 executable for a processor 260.

The control flow graph (CFG) generator 243 is configured to process high-level shader code 202 and generate the CFG by analyzing the logical structure of the shader program 202 to represent the flow of control between different basic blocks of code. The CFG generator 243 is configured to parse the high-level shader code 202 and identify conditional branches, loops, and function calls within the code 202. Each basic block, i.e., a straight-line code sequence with no internal jumps or branches, is connected to other blocks to reflect potential paths of execution. The CFG generator 243 utilizes this flow to perform optimization, such as dead code elimination, loop unrolling, and branch prediction, ensuring efficient code execution when transformed into a target code 206. This CFG generator 243 further maps complex control structures, enabling the compiler system 240 to optimize shader performance for execution on one or more processors 260.

In one implementation, the DAG generator 244 is configured for extraction of a directed acyclic graph (DAG) of each basic block from the generated CFG. This includes analyzing the internal structure of each basic block to identify dependencies and relationships between individual operations or instructions within each block. The DAG generator 244 traverses the CFG to locate each basic block and subsequently decomposes the block into a DAG, wherein nodes represent operations and edges represent dependencies that dictate the order of execution. The resulting DAG allows the compiler system 240 to optimize instruction scheduling, register allocation, and parallel execution by revealing opportunities for reordering instructions without altering the program's semantic correctness.

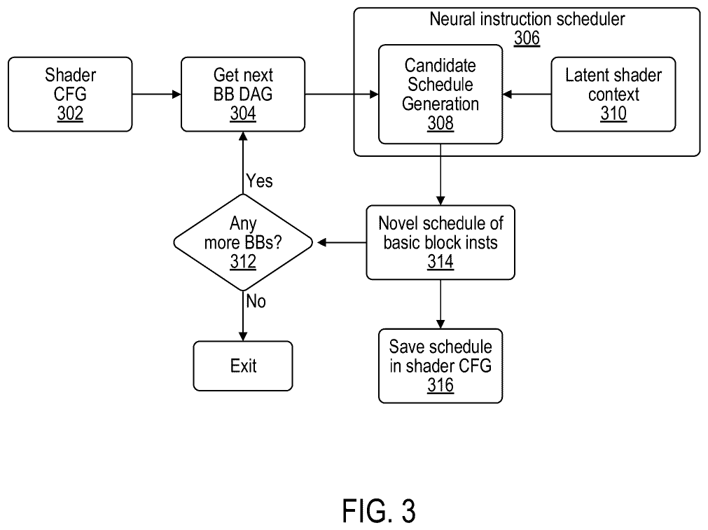

The scheduler 246 organizes, allocates, and determines execution timing of instructions retrieved from each basic block, such that these instructions are executed on a specified component group or type within the processor 260, following a defined execution order and specific clock cycle. The scheduler 246 refers to the DAG to identify optimal execution sequences for each instruction represented by the vertices in the DAG. These instructions correspond to nodes of the basic block. The scheduler 246 generates candidate sequences using one or more machine learning models that order the instructions based on learned patterns and data-driven value estimation, rather than adhering to any pre-determined heuristic or strategy. This approach to instruction scheduling enables more flexible instruction scheduling, overcoming the limitations and biases inherent in the current heuristic-based approach. Additional information on the scheduler is provided below in reference to FIGS. 3-7.

The compiler system 240 further includes an optimizer 248 that optimizes the instructions scheduled by the scheduler 246 in accordance with runtime constraints 204. For instance, if the runtime constraint 204 pertains to power usage, the optimizer 248 may delay the execution of certain instructions to comply with the power limit. The optimizer 248 has complete visibility of the entire execution sequence of the scheduled instructions, as these instructions are assigned to specific clock cycles and components of the processor 260. The optimizer 248 analyzes and transforms the IR of the source code 202 and applies a series of optimizations, including but not limited to, dead code elimination, loop unrolling, instruction reordering, constant folding, and register allocation. These transformations aim to minimize resource usage, reduce execution time, and adhere to constraints such as power consumption or memory limits. The resulting optimized code is then prepared for final code generation to be executed on the target hardware platform.

The assembler 250 carries out the steps of compilation and packaging of the scheduled instructions to produce the target code 206. The assembler 250 maps the scheduled instructions to the specific hardware version of processor(s) 260 being utilized and determine the appropriate component queue for each instruction. Additionally, the assembler 250 can package the DAG in an encrypted format, along with constraint metadata representing the actual constraints 204 for the final set of assembled instructions produced by the scheduler 246. The processor(s) 260 include specialized hardware devices capable of accepting a non-standard instruction set for processing high-level shader code, such as the high-level shader code 202. Once the high-level shader code 202 is compiled into the target shader code 206 by the compiler system 240, as described above, the target code 206 can be transmitted to or loaded onto a processor 260, which then executes the machine instructions contained in the target code 206. The processor 260 can include various components such as matrix arithmetic blocks, numerical conversion blocks, vector computation blocks, memory components, data permutation blocks, and input/output buses. These functional components can be clocked either with a single clock or with different clocks. Other implementations are contemplated.

Referring now to FIG. 3, a block diagram describing generation of instruction schedules based on a shader control flow graph (CFG) is illustrated. As described in the foregoing, a compiler (such as compiler system 240) accesses a control flow graph from a high-level shader code (e.g., code 202) and extracts, from the CFG, basic blocks as represented by directed acrylic graph (DAG) associated with the CFG. In one or more implementations, described herein, one or more machine learning models (e.g., neural networks) replace a traditional scheduler in a compilation process. The proposed neural instruction scheduler 306 operates by iterating over all the basic blocks in the DAG 304, as extracted from the accessed shader CFG 302. Further, instead of using heuristics for scheduling instructions, the neural instruction scheduler 306 is called upon each basic block. Furthermore, as the shader is scheduled, a latent shader context cache 310 is updated to reflect the basic blocks that have already been scheduled. The latent shader context provides information to the neural instruction scheduler 306 pertaining to instructions that have already been scheduled for the instruction that is currently being scheduled.

In operation, each basic block DAG 304 is fed into the neural instruction scheduler 306, which uses the DAG 304 to operate a candidate schedule generation operation 308. In an implementation, this operation 308 firstly includes analyzing the nodes and the edges of the DAG 304. The basic block DAG 304 is a representation to depict dependencies and execution order of instructions within a basic block. In one implementation, each node in the DAG 304 corresponds to a single instruction or operation, while edges between nodes indicate encoded data dependencies or a sequence in which instructions must be executed to maintain correctness. Further, no instruction is dependent on itself, which prevents infinite loops within the basic block. In an implementation, the nodes of the DAG 304 represent instructions in the form of an IR of the high-level shader code.

For each basic block, the neural instruction scheduler 306 executes a scheduling operation 308, that includes generation of candidate schedules for instructions corresponding to each basic block. In one implementation, the neural instruction scheduler 306 generates instruction schedules for instructions associated with the basic block using one or more neural networks. In one example, each such neural network is trained to predict a value of a performance metric associated with scheduling an instruction. In one or more implementations, this metric can include predicted values (e.g., in the form of neural approximation) of GPU runtime, memory usage, power usage, etc. associated with scheduling an instruction. The scheduler 306 compares the predicted performance metrics for a given instruction with predicted metrics of other instructions to determine which instruction to select next. This process is autoregressively repeated until there are no more instructions left.

In one implementation, a latent shader context 310 is also fed to the neural network(s) during the scheduling operation 308. The latent shader context, in one example, includes a vector which represents information about various types of instructions in a given basic block and whether these instructions have already been executed. The latent shader context 310 further represents information about the types of instructions that have not yet been executed (or instructions that might be ready yet). This information enables the neural network(s) to determine which instructions can be scheduled.

The neural network(s) are executed by the scheduler 306 to generate candidate schedule for a current basic block as represented by its corresponding DAG. These novel candidate schedule(s) 314 of basic block instructions are outputted by the scheduler 306 and saved 316 as in the shader CFG, which ultimately generates a target code (e.g., target shader code 206) for further processing using the data outputted by the scheduler 306 corresponding to the instruction schedules. In an implementation, when generation of candidate schedules for a basic block is complete, i.e., all instructions associated with the basic block undergo the scheduling operation 308, the compiler can determine whether any more basic blocks are remaining (e.g., as shown by decision block 312). If no more basic blocks are present the compilation process ends. Otherwise, the compiler retrieves the next basic block DAG 304 and neural instruction scheduler 306 generates candidate schedules for the basic block, as described above.

The implementations described herein introduce a system-level compilation process that infuses mechanics of instruction scheduling into autoregressive neural networks. The approaches discussed allow for the generation of a large number of candidate schedules, significantly expanding the potential solution space. In one example, the scheduling process described narrows the search space from N! (where “N” is the number of instructions in the basic block) to be equal to or less than N. The set of legal schedules, i.e., a number that can be computed from the basic block's DAG is therefore reduced to a large extent. In an implementation, the machine learning models described herein order the instructions based on learned patterns and data-driven performance metric estimation, rather than adhering to any pre-determined heuristic or strategy. This novel approach to instruction scheduling can enable more flexible instruction scheduling, overcoming the limitations and biases inherent in the current heuristic-based approach. These and other implementations are further detailed with respect to the discussion that follows.

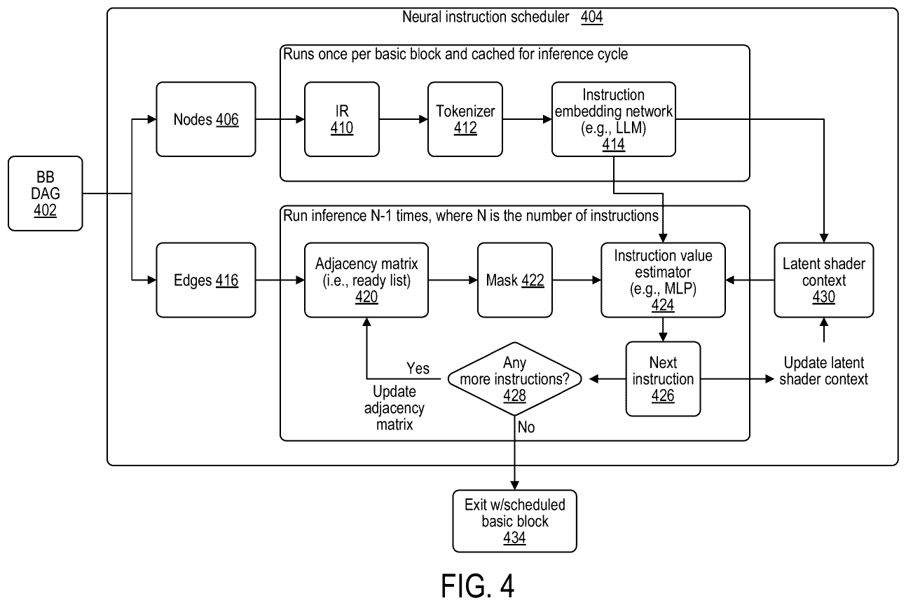

FIG. 4 illustrates a block diagram of various components of a neural instruction scheduler. In the implementations described herein, a machine-learning based instruction scheduler is discussed. In one implementation, a neural instruction scheduler 404 replaces traditional scheduler(s) in the compilation process, and in a similar fashion operates by iterating over basic blocks of a computer program code, e.g., as represented using directed acyclic graphs (DAGs). However, for each DAG, instead of using traditional methods of scheduling such as executing scheduling heuristics or other machine learning strategies for scheduling, the neural instruction scheduler (or simply “scheduler 404”) is executed on each basic block. Further, as the shader code is scheduled, a latent shader context cache is updated to reflect basic blocks that have already been scheduled. In one or more implementations, processes discussed herein are executed by various specialized hardware circuitries that form the scheduler 404. These can include processing circuitries, instruction queues, dependency checkers, and control logic units designed to manage the sequencing and dispatch of instructions to optimize execution order.

As shown, a given basic block DAG 402 is accessed by the scheduler 404 for scheduling individual instructions contained in the basic block. In an implementation, each incoming basic block is represented by a DAG, such that edges and nodes of the DAG are used at inputs by different processes of the instruction scheduler 404. In one example, each node 406 of the DAG 402 represents instructions associated with the basic block. In an implementation, these nodes 406 represent the instructions in the form of compiler IR 410 (e.g., IR generated by IR generator 242). In one implementation, the IR 410 is converted into multiple tokens. In one example, a tokenizer 412 accesses the IR 410 of the shader code and segments the IR 410 into discrete tokens that encapsulate individual syntactic or semantic components, such as variables, operators, and functional directives. The scheduler 404 executes the tokenizer 412 configured to process the IR 410 and generate a set of tokens, each representing distinct semantic or syntactic elements. These tokens are then mapped to corresponding embeddings within an embedding space, wherein each embedding is a multi-dimensional vector representation encapsulating the contextual and relational properties of the token. In one implementation, the scheduler 404 is further configured to execute an instruction embedding neural network 414, which utilizes a Natural Language Processing (NLP)-based approach to perform retrieve embeddings from the generated tokens. In one example, the neural network 414 includes a trained (or pre-trained) Large Language Model (LLM). As each instruction is composed of multiple tokens (i.e., multiple elements from the embedding space), the neural network 414 can utilize a weighted attention method to combine these embeddings into a single vector. Each such vector represents an instruction in a latent semantic space. In one example, these vectors are cached and reused as they do not change throughout the scheduling process. That is, the neural network 414 is executed once per basic block and the generated vectors are cached for the inference cycle.

The instruction embeddings are fed into a value estimator 424, along with a mask 422 that is generated from an adjacency matrix 420 and a latent shader context 430. In an implementation, the adjacency matrix identifies a “ready-list” of instructions that are valid. During the scheduling process, the list of instructions which are ready to be scheduled are tracked by the “ready list.” In one implementation, this list can be derived from the edges 416 of the DAG 402, e.g., to create the adjacency matrix 420. In one example, the adjacency matrix 420 is a binary matrix that encodes data-level dependencies between instructions. In operation, a node 406 of the DAG 402 is considered adjacent to another node 402 when it is dependent on that node 406. This is a one-way relationship and therefore, the adjacency matrix 420 is asymmetrical. In the implementations described herein, the adjacency matrix 420 is used to mask out invalid instructions, such that the value estimator 424 can only select instructions from the valid set. In some implementations, invalid instructions, or instructions that are otherwise not ready, are masked by using masked attention to create the mask 422. In one example, the adjacency matrix 420 is generated as a vector representation describing relationships between edges 416 of the DAG 402.

The latent shader context 430, in an implementation, is another vector representation that represents a scheduling status for each instruction. In one example, the scheduling status can include information about the types of instructions that have already been executed, as well as information about the types of instructions that have not yet been executed (or are otherwise not ready). Both vectors (i.e., adjacency matrix 420 and shader context 430) provide information to the value estimator 424 in terms of what instruction to schedule next (a decision that is sensitive to the order of instructions). In an implementation, the value estimator 424 is configured to predict a value of a performance metric associated with scheduling each valid instruction and compare these values against each other to determine the next instruction 426 to be selected. In an implementation, the latent shader context 430 is initially created based on embeddings generated by the neural network 414.

In one example, the value estimator 424 is inferred “N−1” times, wherein N is the number of instructions of the basic block. The value estimator 424, in one implementation, includes a multi-layer perceptron (MLP)-based neural network with autoregression. The value estimator 424 is configured to predict sequential values while accounting for dependencies between previously processed instructions and current instruction being processed. The estimator 424 can include an input layer for receiving initial feature data and one or more hidden layers that process this data through non-linear transformations to extract high-level features (feature matrix from nodes 406). The output layer provides estimated values influenced by autoregressive components, where previous predictions or output states are recursively fed back into the model as input for subsequent estimations. After each instruction is picked, both the adjacency matrix 420 and shader context 430 are updated, e.g., to reflect the dependency graph and current state of the candidate schedule, respectively. From there, the process of picking the next instruction begins using this same process. This process is autoregressively repeated until there are no more instructions left. As shown, the scheduler 404 determines whether anymore instructions are left (block 428), and updates the adjacency matrix 420 when more instructions are to be processed. Once all instructions are processed, the scheduling process can end and basic blocks with an instruction schedule 434 are outputted.

In an implementation, the value estimator 424 includes learnable parameters and is configured to select a candidate instruction schedule from multiple generated schedules based on analysis of the predicted performance metrics. Analysis of these metrics include data dependency analysis to prevent pipeline hazards, latency estimation to minimize stalls, and parallelism opportunities to maximize concurrent execution. In an implementation, the metrics include power consumption, register allocation, memory hierarchy constraints, and instruction throughput, which can be used to select instruction schedules that aim to balance workload distribution and prevent bottlenecks. In cases where the neural instruction scheduler 404, as described above, is unavailable during the scheduling process, the compilation system may default to traditional scheduling mechanisms such as using heuristics based predictive models for scheduling instructions.

One of the key differentiators of the proposed neural instruction scheduler is the automatic learning of a representation of source code directly from the compiler IR, in contrast to the existing approaches that either look at program features hand-selected by human experts (limiting the information that can be extracted) or create estimates of program behavior using simplified abstractions of the hardware to make the scheduling decision. Another advantage of the methods discussed herein that neural instruction scheduler is designed with flexibility to create any valid order of instructions and trained to learned to produce highly performant instruction orderings. This is in contrast to heuristic-based schedulers, which have a fixed number of schedules, which is a number that is significantly smaller than the number of possible schedules, especially for large basic blocks. Because of this, the neural instruction scheduler can produce schedules more dynamically and, with an effective and data-driven evaluation heuristic, can obtain improved runtime performance relative to the heuristic-based approach.

At the compilation system level, another advantage of the proposed scheduler is that program representation is automatic and free of human bias. That is, not only is the solution a more complete input representation than fixed-length feature vector approaches but can also automatically keep this representation up to date as IR evolves. Further, the scheduling methods described herein reduce the need to invest resources into the development and maintenance of heuristics. This makes the scheduler easier to maintain as the model can be retrained in an automated fashion when new performance data becomes available.

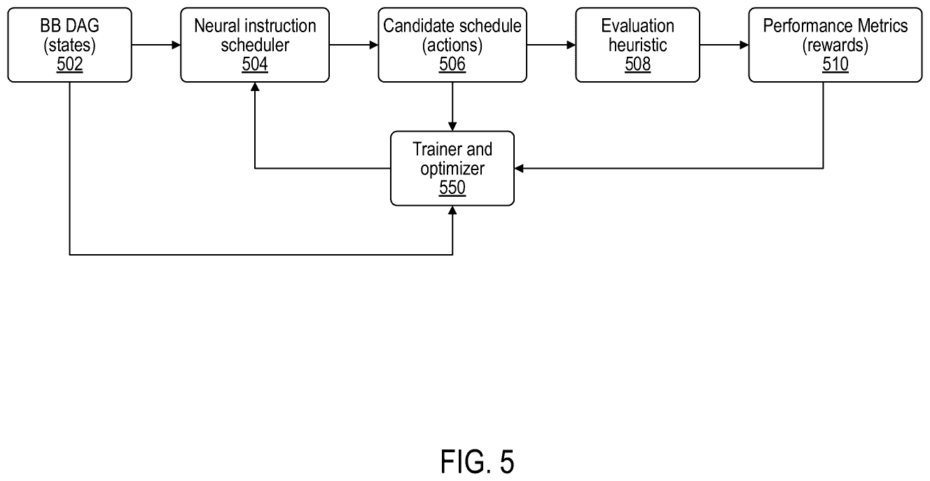

FIG. 5 is a block diagram illustrating training of a neural instruction scheduler using reinforcement learning. In one or more implementations, neural instruction scheduler 504 is trained to predict performance metrics for generating candidate schedules for instructions associated with basic blocks. For instance, the neural instruction scheduler 504 is trained prior to being deployed within the compilation process. In an implementation, to train the neural instruction scheduler 504, the trainer and optimizer circuitry 550 is provided with expected performance metrics, e.g., expected runtime, as a “reward function” 510. The expected runtime, in one example, includes estimates of latency of sequences of instructions as the reward function 510. These performance metrics are generated as an output of a value estimator (e.g., value estimator 424 shown in the FIG. 4). The value estimator is trained on an intermediate representation of the shader code at a basic block level, e.g., to predict cycle times of a given schedule of instructions. The training loop is standard for value-based reinforcement learning algorithms like Deep-Q Network (DQN), and enables offline evaluation of novel candidate schedules, which in turn reduces the cost of training by removing online evaluation of the scheduler 504 from the training loop.

In the example shown in FIG. 5, to train the neural instruction scheduler 504 using reinforcement learning, basic block DAGs 502 are used as “states”, candidate schedules 506 are used as “actions”, and “rewards” 510 are extracted from an evaluation heuristic 508. In reinforcement learning, a “state” represents the current situation or configuration of the environment that the agent (herein the neural instruction scheduler 504) observes at a given time step. It encapsulates all the necessary information that the neural instruction scheduler 504 needs to decide its next action. The “action” is a decision or move that the neural instruction scheduler 504 can take in response to a given state in the environment. Each action taken by the neural instruction scheduler 504 influences the environment and transitions it into a new state, generating corresponding rewards or penalties. The “reward” is represented by a performance metric 510 (e.g., expected runtime) associated with scheduling instructions of the basic block based on the generated candidate schedule 506.

In the shown example, the neural instruction scheduler 504 interacts with an environment represented by a set of basic block DAGs 502 and takes actions (i.e., generates candidate schedules 506), that transition the scheduler 504 between DAGs 502 to achieve a defined goal. The scheduler 504 selects candidate schedules, in one example, based on a policy that maps DAGs 502 to schedules 506, which is iteratively refined through training. Upon executing a candidate schedule and reaching a subsequent DAG 502, a reward is generated, quantifying the effectiveness of the action. This reward is represented by performance metric 510, which include one or more metrics associated with scheduling instructions of the basic block based on the generated candidate schedule 506. In some implementations, this reward is determined using the evaluation heuristic 508 designed to estimate the value or utility of the candidate schedule relative to the performance metrics, such as expected runtime, memory usage, power usage, etc. The heuristic 508 considers factors such as objectives, resource efficiency, and strategic progress. The scheduler 506 utilizes these rewards to update its policy, optimizing future decisions to maximize cumulative rewards over time.

In one implementation, the evaluation heuristic 508 is an analytical model found in traditional production compilers. In other implementations, the evaluation heuristic 508 is an instruction-level shader performance prediction model. In either case, the training method described herein has the advantage of significantly higher correlation between candidate schedules 506 and performance metrics 510, as the evaluation heuristic 508 significantly shortens the delay between observations, actions, and rewards compared to traditional training mechanisms. Further, the reward signal is significantly less noisy as the evaluation heuristic 508 provides expectations rather than noisy runtime observations. Furthermore, the proposed training mechanism has a better scaling probability as the system is not bottlenecked by waiting to observe the runtimes of GPU programs.

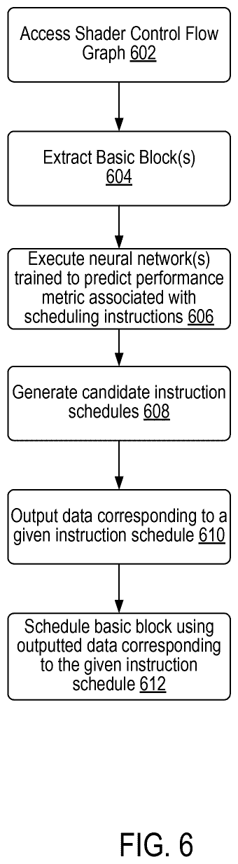

FIG. 6 illustrates a method for generating candidate schedules for scheduling instructions corresponding to a computer program. In an implementation, the computer program is represented using a control flow graph (CFG) that is indicative of a logical structure of the program as well as the flow of control between different basic blocks of the program. In one implementation, a compilation system accesses the CFG corresponding to the computer program (block 602). An instruction scheduler comprised within the compilation system then extracts basic block(s) from the CFG corresponding to the computer program (block 604). In one implementation, this includes extraction of a directed acyclic graph (DAG) of each basic block from the generated CFG. The scheduler analyzes the internal structure of each basic block to identify dependencies and relationships between individual operations or instructions within each block. The scheduler traverses the CFG to locate each basic block and subsequently decomposes the block into a DAG, wherein nodes represent operations and edges represent dependencies that dictate the order of execution. The resulting DAG allows the compiler system to optimize instruction scheduling, register allocation, and parallel execution by revealing opportunities for reordering instructions without altering the program's semantic correctness.

The scheduler is configured to execute one or more neural networks for each basic block DAG, wherein each neural network is trained to predict an arbitrary performance metric associated with scheduling of instructions (block 606). In one implementation, the neural networks comprise of a instruction embedding network, and an instruction value estimator. The instruction embedding neural network, utilizes a Natural Language Processing (NLP) based approach to perform tokenization of instructions extracted from each basic block DAG and retrieves corresponding embeddings. As each instruction is composed of multiple tokens the neural network utilizes a weighted attention method to combine these embeddings into a single vector. Each such vector represents an instruction in a latent semantic space.

The embeddings are then fed to a value estimator along with a vector representing a list of valid instructions, a mask that masks invalid instructions, and another vector representation that represents a scheduling status for each instruction. The value estimator predicts a value of scheduling each valid instruction and compares them against each other to determine the next instruction to be selected. In one example, the value estimator includes a multi-layer perceptron (MLP)-based neural network with autoregression and is configured to predict sequential values of instructions while accounting for dependencies between previously processed instructions and current instruction being processed. This process is repeated until there are no more instructions left. Once all instructions are processed, the scheduling process ends, and candidate schedules are generated (block 608).

In an implementation, the instruction scheduler is configured to select a candidate instruction schedule from multiple generated schedules based on one or more factors. These factors include data dependency analysis to prevent pipeline hazards, latency estimation to minimize stalls, and parallelism opportunities to maximize concurrent execution. Additionally, considerations such as power consumption, register allocation, memory hierarchy constraints, and instruction throughput are incorporated to balance workload distribution and prevent bottlenecks. Once an instruction schedule is selected, data corresponding to the schedule is outputted (block 610). This data is then utilized to schedule the basic block instructions (block 612).

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
processing circuitry configured to:
access a control flow graph corresponding to a computer program;
generate a plurality of instruction schedules for instructions associated with a basic block of the control flow graph, using one or more neural networks that are trained to predict a performance metric associated with scheduling an instruction; and
output data corresponding to a given instruction schedule of the plurality of instruction schedules.

2. The system as claimed in claim 1, wherein the processing circuitry is further configured to extract, from the control flow graph, a list of valid instructions amongst the instructions associated with the basic block.

3. The system as claimed in claim 2, wherein the list of valid instructions includes encoded dependencies between the instructions.

4. The system as claimed in claim 1, wherein the processing circuitry is configured to train the one or more neural networks to optimize each neural network for predicting the performance metric.

5. The system as claimed in claim 1, wherein the performance metric comprises one or more of runtime, power usage, memory usage or a combination thereof associated with scheduling an instruction using an instruction schedule from the plurality of instruction schedules.

6. The system as claimed in claim 1, wherein to generate an instruction schedule, the processing circuitry is configured to compare a performance metric associated with scheduling a given instruction with corresponding performance metrics associated with scheduling of one or more other instructions.

7. The system as claimed in claim 1, wherein the processing circuitry is further configured to schedule the basic block for execution at least in part using the data corresponding to the given instruction schedule.

8. A method comprising:
accessing, by a processing circuitry, a control flow graph corresponding to a computer program;
generating, by the processing circuitry, a plurality of instruction schedules for instructions associated with a basic block of the control flow graph, using one or more neural networks each trained to predict a performance metric associated with scheduling an instruction; and
outputting, by the processing circuitry, data corresponding to a given instruction schedule of the plurality of instruction schedules.

9. The method as claimed in claim 8, further comprising extracting, by the processing circuitry from the control flow graph, a list of valid instructions amongst the instructions associated with the basic block.

10. The method as claimed in claim 9, wherein the list of valid instructions includes encoded dependencies between the instructions.

11. The method as claimed in claim 8, further comprising training, by the processing circuitry, the one or more neural networks to optimize each neural network for predicting the performance metric.

12. The method as claimed in claim 8, wherein the performance metric comprises one or more of runtime, power usage, memory usage or a combination thereof associated with scheduling an instruction using an instruction schedule from the plurality of instruction schedules.

13. The method as claimed in claim 8, wherein to generate an instruction schedule, the method further comprises comparing, by the processing circuitry, a performance metric associated with scheduling a given instruction with corresponding performance metrics associated with scheduling one or more other instructions.

14. The method as claimed in claim 8, further comprising scheduling, by the processing circuitry, the basic block for execution at least in part using the data corresponding to the given instruction schedule.

15. A compiler system comprising:
at least one memory; and
at least one processor configured to:
access, from the at least one memory, a control flow graph corresponding to a computer program;
extract a basic block from the control flow graph;
generate a plurality of instruction schedules for instructions associated with the basic block, using one or more neural networks each trained to predict a performance metric associated with scheduling an instruction; and
output data corresponding to a given instruction schedule of the plurality of instruction schedules.

16. The compiler system as claimed in claim 15, wherein the at least one processor is further configured to extract, from the control flow graph, a list of valid instructions amongst the instructions associated with the basic block.

17. The compiler system as claimed in claim 16, wherein the list of valid instructions includes encoded dependencies between the instructions.

18. The compiler system as claimed in claim 15, wherein the at least one processor is configured to train the one or more neural networks to optimize each neural network for predicting the performance metric.

19. The compiler system as claimed in claim 15, wherein the performance metric comprises one or more of runtime, power usage, memory usage or a combination thereof associated with scheduling an instruction using an instruction schedule from the plurality of instruction schedules.

20. The compiler system as claimed in claim 15, wherein to generate an instruction schedule, the at least one processor is configured to compare a performance metric associated with scheduling each instruction with corresponding performance metrics associated with scheduling one or more other instructions.
